(19) United States
(12) Patent Application Publication
(10) Pub. No.: US 2005/0101431 A1
(43) Pub. Date: May 12, 2005

(54) Multiple speed transfer case

(76) Inventors: Timothy Allen, Livonia, MI (US); Steven Thomas, Bloomfield Hills, MI (US); Terry Vandenbrink, Carleton, MI (US); Juliette McCoy, Macomb Twp., MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/706,403

(22) Filed: Nov. 12, 2003

(51) Int. Cl. F16H 3/44

(52) U.S. Cl. 475/286

(57) ABSTRACT

A four wheel drive vehicle having an automatic transmission and a transfer case. The transfer case includes a planetary gear set and a pair of multi-plate, hydraulically controlled clutches coupled to the gear set for shifting between a high gear ratio and a low gear ratio. The transfer case also includes a four wheel drive, multi-plate, hydraulically controlled clutch coupled to the output of the gear set for switching between a two wheel drive mode and a four wheel drive mode. The hydraulic valving and controls for the hydraulic clutches in the transfer case can be contained in the automatic transmission, with fluid passages to communicate the fluid to the clutches. The planetary gear set in the transfer case can be employed with the planetary gear sets in the transmission to expand the range of output gear ratios from the transfer case.

### BACKGROUND OF INVENTION

The present invention relates to transfer cases and more particularly to transfer cases employed with automatic transmissions on four wheel drive vehicles.

One type of conventional four wheel drive vehicle has an automatic transmission that is connected to and driven by a torque converter, with the output of the transmission connected to the input of a transfer case. The transfer case includes a planetary gear set that is controlled by a lever or switch in the passenger compartment of the vehicle. A first position of the lever will cause the planetary gear set of the transfer case to pass the torque from the transmission through to one or more drive shafts in essentially a 1:1 drive ratio the high mode. A second position of the lever will cause the planetary gear set of the transfer case to pass the torque through with a reduced gear ratio, such as 2:1 the low mode. The transfer case also includes a sliding or other manually operated type of clutch that is used to engage and disengage a sprocket and chain assembly. When engaged, the sprocket and chain assembly allows the torque to be transmitted to a secondary axle as well as the primary axle (i.e. four wheel drive), and when disengaged, the torque is only transmitted to the primary axle of the vehicle (i.e. two wheel drive). Consequently, with these types of conventional four wheel drive systems for vehicles, the shifting from high to low and two wheel drive to four wheel drive requires manual intervention and is generally limited to below certain vehicle speeds.

Recently, there has been an increased desire for vehicles to be equipped with interactive vehicle dynamics (i.e. vehicle stability control) systems, which automatically assist the driver with vehicle operation. An advantage of these systems is that, through electronic controls, they can automatically assist the driver without any driver intervention. With a conventional four wheel drive system requiring manual intervention to shift between high and low, as well as two and four wheel drive, this would force an interactive vehicle dynamics system to be more limited in its capabilities on these vehicles.

There is an additional desire to improve the fuel economy of the conventional four wheel drive vehicles. With the extra weight of the additional components needed for a four wheel drive vehicle, the fuel economy tends to be worse than with a two wheel drive vehicle. One way to improve the fuel economy is to increase the number of gear ratios in the automatic transmissions employed with these vehicles. However, an additional gear set in an automatic transmission requires an expensive redesign of an existing automatic transmission, and adds to the cost and size of the transmissions.

Thus, it is desirable to have a four wheel drive vehicle with an automatic transmission and a transfer case that allows for automatic shifting between two wheel drive and four wheel drive as well as automatic shifting between the high and low gear ratios in the transfer case at a wide range of vehicle speeds thus allowing for compatibility with interactive vehicle dynamics systems and also allows the gear set in the transfer case to be employed with the automatic transmission to allow for an expanded range of automatic gear ratios thus improving the fuel economy of the four wheel drive vehicle.

### SUMMARY OF INVENTION

In its embodiments, the present invention contemplates a transfer case for a four wheel drive vehicle, having an automatic transmission with an output shaft, with the transfer case adapted to mount to the transmission. The transfer case includes a planetary gear set drivable by the transmission output shaft and having a sun gear, a planet gear carrier assembly, and a ring gear, a first clutch operatively engaging the planetary gear set, with the first clutch engagable and disengagable by changes in pressure of a hydraulic fluid, and a second clutch operatively engaging the planetary gear set, with the second clutch engagable and disengagable by changes in pressure of the hydraulic fluid. A primary output device is drivable by the planetary gear set. The transfer case also includes a secondary output device, and a third clutch operatively engaging the primary output device and the secondary output device, with the third clutch engagable and disengagable by changes in pressure of the hydraulic fluid to thereby selectively couple and decouple the secondary output device to the primary output device.

An embodiment of the present invention allows for the flexibility of an additional planetary gear set for changing drive ratios with minimal modifications to an existing automatic transmission in a four wheel drive vehicle. This allows, for example, transmission/transfer case systems that employ a four speed automatic transmission to operate like a five speed automatic transmission.

An advantage of an embodiment of the present invention is that the fuel economy of a four wheel drive vehicle is improved.

Another advantage of an embodiment of the present invention is that the performance of a four wheel drive vehicle is improved.

A further advantage of an embodiment of the present invention is that the transmission/transfer case systems will allow for automatic shifting between two wheel drive and four wheel drive, as well as shifting between high and low including while the vehicle is in motion which allows for the use of interactive vehicle dynamics with vehicles having these transmission/transfer case systems.

An additional advantage of an embodiment of the present invention is that the transmission/transfer case systems are generally lighter weight and easier to package than transmission/transfer case systems with an additional planetary gear set added to the transmission.

Another advantage of an embodiment of the present invention is that the hydraulic clutches employed in the transfer case can be powered by the automatic transmission hydraulic pump. Also, the control solenoids/valves for controlling the hydraulics in the transfer case can be located in the automatic transmission. Further, this allows for the oil employed by the transfer case to be cooled by the transmission oil cooler.

### BRIEF DESCRIPTION OF DRAWINGS

FIG. 1 is a schematic view of transmission and transfer case gear sets and clutches, in accordance with the present invention.

FIG. 2 is a sectional view of a portion of a transmission system and a transfer case system, in accordance with the present invention.

FIG. 3 is a table indicating clutch and band engagements for different vehicle operating conditions, in accordance with the present invention.

### DETAILED DESCRIPTION

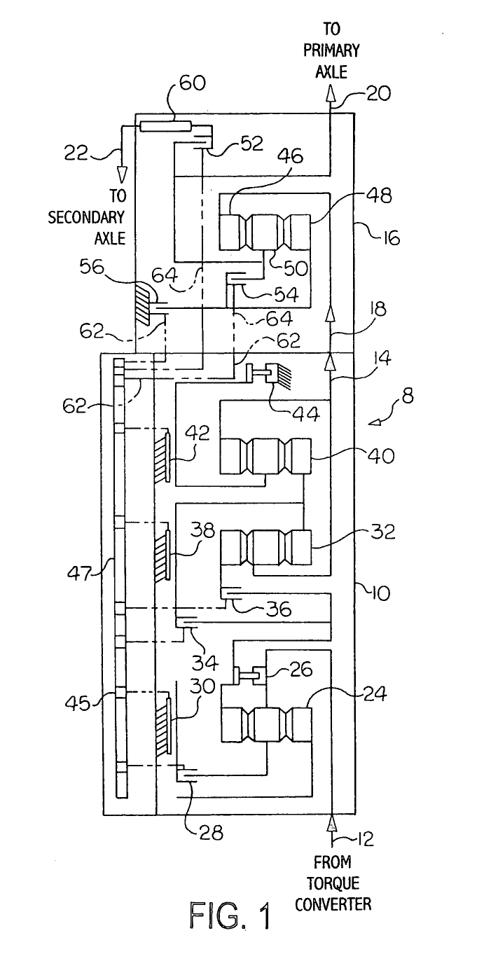

FIG. 1 illustrates a portion of a vehicle drivetrain 8 having an automatic transmission system 10, which has an input 12 from a torque converter (not shown) and an output 14 to a transfer case system 16. The transfer case 16 has a input 18 and a first output 20 to a driveline (not shown) leading to a primary axle (not shown) and a second output 22 to a second driveline (not shown) leading to a secondary axle (not shown).

The automatic transmission 10 includes a first planetary gear set 24 that receives torque from the input 12. The first planetary gear set 24 operates in cooperation with a first one-way clutch 26, a fist, multi-plate, hydraulic clutch 28, and first friction band 30 to change the drive ratio and transfer torque to a second planetary gear set 32. The second planetary gear set 32 operates in cooperation with a second, multi-plate, hydraulic clutch 34, a third, multi-plate, hydraulic clutch 36, and a second friction band 38 to change the drive ratio and transfer torque to a third planetary gear set 40 or to the transmission output 14. The third planetary gear set 40 operates in cooperation with a third friction band 42 and a second one-way clutch 44 to change the drive ratio and transfer torque to the transmission output 14. The transmission output 14 transfers the torque to the transfer case input 18. The multi-plate clutches 28, 34, 36 and the friction bands 30, 38, 42 are connected by fluid passages to and controlled by valves 45 in a valve body 47. The hydraulic fluid passages are indicated by phantom lines in FIG. 1.

The transfer case input 18 transfers the torque to a planet gear carrier 46 of a transfer case planetary gear set 48. The transfer case planetary gear set 48 includes a sun gear 50 that connects to the primary axle output 20, and to the secondary axle output 22 via a four wheel drive, multi-plate, hydraulic clutch 52.

This clutch 52 is used to control the torque transfer to the second output 22 (via a chain and sprocket assembly 60), thus switching between two wheel drive (when the clutch 52 is not engaged) and four wheel drive (when the clutch 52 is engaged). The transfer case 16 includes a high range, hydraulic, multi-plate clutch 54 and a low range, hydraulic, multi-plate clutch 56. These two clutches 54, 56 are used to control the ratio state (i.e. under-drive or 1:1 ratio) in the transfer case 16. When the low range clutch 56 is engaged, then the under-drive (i.e. low) ratio is output, and when the high range clutch 54 is engaged, then the 1:1 drive ratio is output.

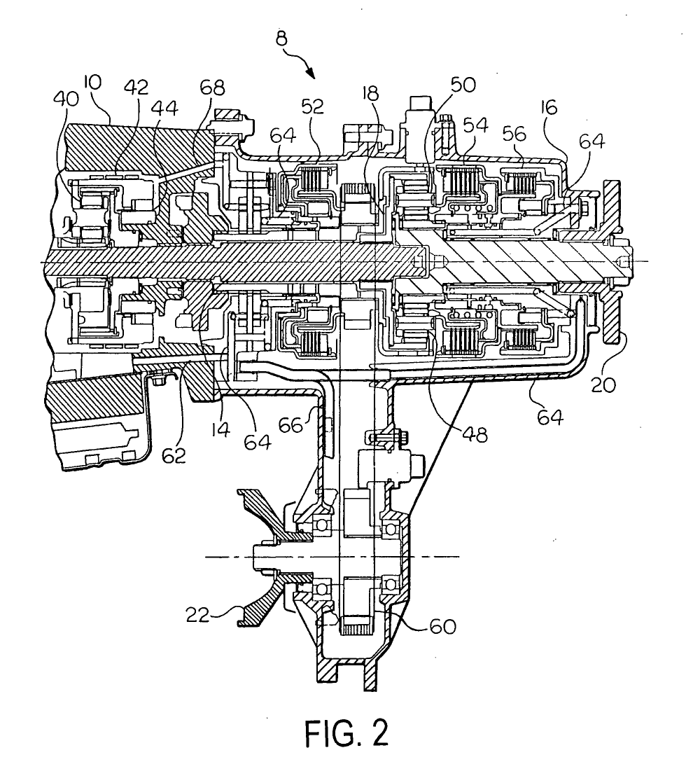

FIG. 2 illustrates a portion of the automatic transmission 10 and transfer case 16 in greater detail. As discussed above, the output 14 of the transmission 10 connects to and drives the input 18 of the transfer case 16. This input 18 is coupled to the transfer case planetary gear set 48. The high range clutch 54 and the low range clutch 56 are coupled to and control whether the ratio to the first transfer case output 20 is at a 1:1 drive ratio or a reduced drive ratio. The four wheel drive clutch 52 is coupled to the first transfer case output 20 on one side of the clutch, while the other side of the clutch 52 is coupled to a chain and sprocket assembly 60. The chain and sprocket assembly 60 is, in turn, coupled to the second output 22 for the transfer case 16.

The three hydraulic clutches 52, 54, 56 control the shifting from two to four wheel drive and from the 1:1 to under-drive ratio, and so a supply of pressurized hydraulic fluid is needed to control engagement and disengagement of these clutches 52, 54, 56. Also, some of the mechanical components in the transfer case 16 require lubrication. In order to provide the needed fluid, there are three feed passages 62 (only one shown in FIG. 2) extending from the transmission 10 into the transfer case 16, one each for selectively supplying pressurized fluid for a respective one of the clutches 52, 54, 56. Each of these passages 62 connects up with a series of fluid passages 64 in the transfer case that lead to the respective actuator for its associated clutch. A pump (not shown) in the transfer case 16 provides for the transfer case lubrication and cooling by employing the hydraulic fluid that enters the transfer case 16 from the transmission 10. The pump also pushes the fluid into suction pick-up passages 66, which lead to a scavenge return passage 68, allowing the fluid to return to the transmission 10. The returned fluid can then be filtered and cooled by a conventional transmission oil cooler (not shown).

The automatic transmission 10 also provides the electro-hydraulic control solenoids and valving (not shown in FIG. 2), which in turn provide the hydraulic power and control for the three transfer case clutches 52, 54, 56. Since the solenoids and valving operate in the same way as with these types of components on a conventional automatic transmission, they will not be discussed in any detail herein.

By having electro-hydraulic controls for all of the shifting in both the automatic transmission 10 and the transfer case 16 so no driver intervention is required and all shifting being able to occur while the vehicle is moving, this drivetrain is compatible with the use of an interactive vehicle dynamics system, which improves the vehicle responsiveness for the driver.

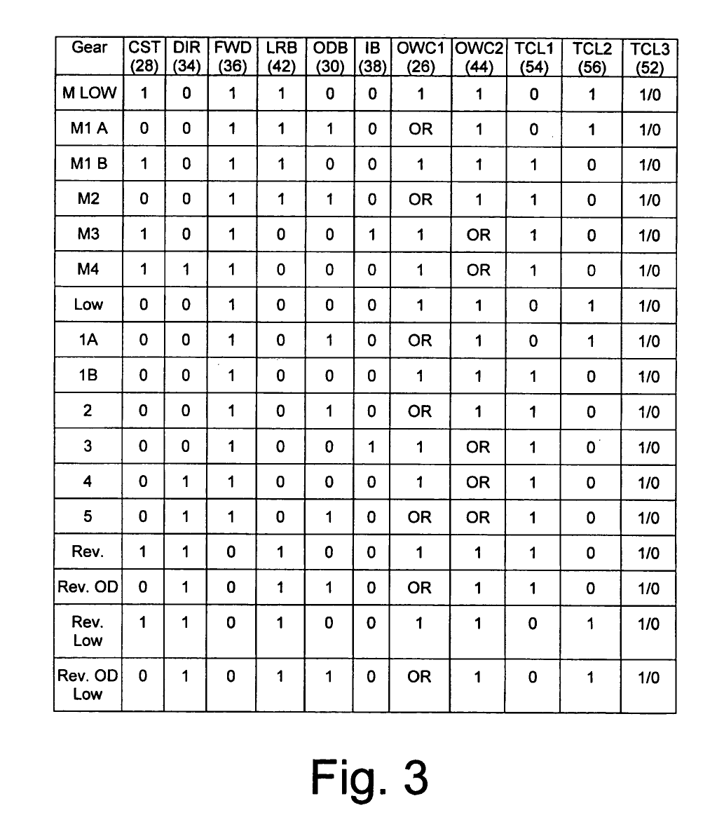

FIG. 3 illustrates the clutch and band engagements that correspond to the various gear ratios available for the vehicle. Across the top row of the table is a list of the various clutches and bands, with the element number shown in FIGS. 1 and 2 in parentheses. Along the left most row is a list of the particular gear ratios. For the multi-plate clutches and the bands, a 1 indicates that the particular clutch/band is engaged for that corresponding gear ratio, while a 0 indicates that the particular clutch/band is not engaged. For the one-way clutches, a 1 indicates that the clutch is engaged for that corresponding gear ratio, while an OR indicates that the one-way clutch is over-running for that corresponding gear ratio. One will note that the TCL3 clutch which is the four wheel drive clutch 52 in the transfer case indicates a 1/0 for all of the gear ratios. This is because clutch 52 switches the transfer case between the two wheel drive mode (a clutch disengaged condition, which is a 0) and a four wheel drive mode (a clutch engaged condition, which is a 1). And, since the vehicle can operate in either two wheel drive or four wheel drive for all gear ratios, this clutch 52 can be in either mode.

As for the gear ratios shown in the left most column of FIG. 3, the gear ratios beginning with an M represent vehicle operating conditions when the transmission and transfer case are operating in a manual mode, so there can be engine braking during vehicle operation. MLOW is the manual mode low gear, M1A is a manual mode first gear for normal operating conditions, M1B is a manual mode for first gear when the vehicle is operating in slippery conditions such as driving over snow, M2 is manual second gear, M3 is manual third gear, and M4 is manual fourth gear. The gear ratios for LOW through 5 represent normal vehicle operating conditions when the transmission and transfer case are operating in normal automatic mode. Low is a normal low gear, 1A is a first gear for a normal mode, 1B is first gear for a vehicle operating in slippery conditions, and 2-5 are normal second through fifth gears. The gear ratios for Rev. through Rev. OD Low represent the vehicle operating conditions where the vehicle is backing-up. Rev. is normal reverse gear, Rev. OD is reverse gear with overdrive cancel, Rev. Low is normal reverse gear with the transfer case in its low gear, and Rev. OD Low is the same as Rev. Low but with overdrive cancel. All of the above noted gear ratios can be obtained automatically, without any driver intervention, and while the vehicle is moving, thus allowing for integration of interactive vehicle dynamics with this automatic transmission/transfer case assembly. Also, one will note that this four speed automatic transmission and transfer case combination allows for a very broad range of gear ratios, thus allowing for improved fuel economy.

While certain embodiments of the present invention have been described in detail, those familiar with the art to which this invention relates will recognize various alternative designs and embodiments for practicing the invention as defined by the following claims.

1. A transfer case for a four wheel drive vehicle, having an automatic transmission with an output shaft, the transfer case adapted to mount to the transmission and comprising:
a planetary gear set drivable by the transmission output shaft and having a sun gear, a planet gear carrier assembly, and a ring gear;
a first clutch operatively engaging the planetary gear set, with the first clutch engagable and disengagable by changes in pressure of a hydraulic fluid;
a second clutch operatively engaging the planetary gear set, with the second clutch engagable and disengagable by changes in pressure of the hydraulic fluid;
a primary output device drivable by the planetary gear set;
a secondary output device; and
a third clutch operatively engaging the primary output device and the secondary output device, with the third clutch engagable and disengagable by changes in pressure of the hydraulic fluid to thereby selectively couple and decouple the secondary output device to the primary output device.

2. The transfer case of claim 1 wherein the first clutch is a multi-plate hydraulic clutch, engagable by increasing a hydraulic pressure to the first clutch and disengagable by reducing the hydraulic pressure to the first clutch.

3. The transfer case of claim 2 further including a first hydraulic fluid passage having a first end operatively engaging the first clutch and a second end adapted to operatively engage a hydraulic fluid passage in the transmission whereby the hydraulic fluid pressure employed to engage and disengage the first clutch is suppliable by the transmission.

4. The transfer case of claim 1 wherein the second clutch is a multi-plate hydraulic clutch, engagable by increasing a hydraulic pressure to the second clutch and disengagable by reducing the hydraulic pressure to the second clutch.

5. The transfer case of claim 4 further including a first hydraulic fluid passage having a first end operatively engaging the second clutch and a second end adapted to operatively engage a hydraulic fluid passage in the transmission whereby the hydraulic fluid pressure employed to engage and disengage the second clutch is suppliable by the transmission.

6. The transfer case of claim 1 wherein the third clutch is a multi-plate hydraulic clutch, engagable by increasing a hydraulic pressure to the third clutch and disengagable by reducing the hydraulic pressure to the third clutch.

7. The transfer case of claim 6 further including a first hydraulic fluid passage having a first end operatively engaging the third clutch and a second end adapted to operatively engage a hydraulic fluid passage in the transmission whereby the hydraulic fluid pressure employed to engage and disengage the third clutch is suppliable by the transmission.

8. The transfer case of claim 1 wherein the first clutch is a multi-plate hydraulic clutch, engagable by increasing a hydraulic pressure to the first clutch and disengagable by reducing the hydraulic pressure to the first clutch; the second clutch is a multi-plate hydraulic clutch, engagable by increasing a hydraulic pressure to the second clutch and disengagable by reducing the hydraulic pressure to the second clutch; and the third clutch is a multi-plate hydraulic clutch, engagable by increasing a hydraulic pressure to the third clutch and disengagable by reducing the hydraulic pressure to the third clutch.

9. The transfer case of claim 8 further including a first hydraulic fluid passage having a first end operatively engaging the first clutch and a second end adapted to operatively engage a first hydraulic fluid passage in the transmission whereby the hydraulic fluid pressure employed to engage and disengage the first clutch is suppliable by the transmission; a second hydraulic fluid passage having a first end operatively engaging the second clutch and a second end adapted to operatively engage a second hydraulic fluid passage in the transmission whereby the hydraulic fluid pressure employed to engage and disengage the second clutch is suppliable by the transmission; and a third hydraulic fluid passage having a first end operatively engaging the third clutch and a second end adapted to operatively engage a third hydraulic fluid passage in the transmission whereby the hydraulic fluid pressure employed to engage and disengage the third clutch is suppliable by the transmission.

10. The transfer case of claim 1 wherein the first clutch is a high range clutch and is coupled to the planetary gear set such that, when the first clutch is engaged, an output of the planetary gear set is at about a 1:1 ratio with an input to the planetary gear set.

11. The transfer case of claim 1 wherein the second clutch is a low range clutch and is coupled to the planetary gear set such that, when the second clutch is engaged, an output of the planetary gear set is at a reduced rotational output ratio to an input to the planetary gear set.

12. A transfer case for a four wheel drive vehicle, having an automatic transmission with an output shaft, the transfer case adapted to mount to the transmission and comprising:
planetary gear set drivable by the transmission output shaft and having a sun gear, a planet gear carrier assembly, and a ring gear;
a first multi-plate hydraulic clutch operatively engaging the planetary gear set, with the first clutch engagable and disengagable by changes in pressure of a hydraulic fluid, and with the first clutch being a high range clutch that is coupled to the planetary gear set such that, when the first clutch is engaged, an output of the planetary gear set is at about a 1:1 ratio with an input to the planetary gear set;
a second multi-plate hydraulic clutch operatively engaging the planetary gear set, with the second clutch engagable and disengagable by changes in pressure of the hydraulic fluid, and with the second clutch being a low range clutch that is coupled to the planetary gear set such that, when the second clutch is engaged, an output of the planetary gear set is at a reduced rotational output ratio to an input to the planetary gear set;
a primary output device drivable by the planetary gear set;
a secondary output device; and
a third multi-plate hydraulic clutch operatively engaging the primary output device and the secondary output device, with the third clutch engagable and disengagable by changes in pressure of the hydraulic fluid to thereby selectively couple and decouple the secondary output device to the primary output device.

13. The transfer case of claim 12 further including a first hydraulic fluid passage having a first end operatively engaging the first clutch and a second end adapted to operatively engage a first hydraulic fluid passage in the transmission whereby the hydraulic fluid pressure employed to engage and disengage the first clutch is suppliable by the transmission; a second hydraulic fluid passage having a first end operatively engaging the second clutch and a second end adapted to operatively engage a second hydraulic fluid passage in the transmission whereby the hydraulic fluid pressure employed to engage and disengage the second clutch is suppliable by the transmission; and a third hydraulic fluid passage having a first end operatively engaging the third clutch and a second end adapted to operatively engage a third hydraulic fluid passage in the transmission whereby the hydraulic fluid pressure employed to engage and disengage the third clutch is suppliable by the transmission.

14. A drivetrain for a four wheel drive vehicle comprising:
an automatic transmission having a transmission input and a transmission output shaft; and
a transfer case mounted to the transmission having a planetary gear set coupled to the transmission output shaft and having a sun gear, a planet gear carrier assembly, and a ring gear; a first clutch operatively engaging the planetary gear set, with the first clutch engagable and disengagable by changes in pressure of a hydraulic fluid; a second clutch operatively engaging the planetary gear set, with the second clutch engagable and disengagable by changes in pressure of the hydraulic fluid; a primary output device drivable by the planetary gear set; a secondary output device; and a third clutch operatively engaging the primary output device and the secondary output device, with the third clutch engagable and disengagable by changes in pressure of the hydraulic fluid to thereby selectively couple and decouple the secondary output device to the primary output device.

15. The drivetrain of claim 14 wherein the transfer case includes a first transfer case fluid passage having a first end operatively engaging the first clutch and a second end, and the transmission further includes a valve body with at least three control valves, and a first transmission fluid passage having a first end in communication with a first one of the at least three control valves and a second end in fluid communication with the second end of the transfer case fluid passage, whereby the hydraulic fluid pressure selectively employed to engage and disengage the first clutch is supplied by the first one of the at least three control valves in the transmission.

16. The drivetrain of claim 15 wherein the transfer case includes a second transfer case fluid passage having a first end operatively engaging the second clutch and a second end, and the transmission further includes a second transmission fluid passage having a first end in communication with a second one of the at least three control valves and a second end in fluid communication with the second end of the second transfer case fluid passage, whereby the hydraulic fluid pressure selectively employed to engage and disengage the second clutch is supplied by the second one of the at least three control valves in the transmission.

17. The drivetrain of claim 16 wherein the transfer case includes a third transfer case fluid passage having a first end operatively engaging the third clutch and a second end, and the transmission further includes a third transmission fluid passage having a first end in communication with a third one of the at least three control valves and a second end in fluid communication with the second end of the third transfer case fluid passage, whereby the hydraulic fluid pressure selectively employed to engage and disengage the third clutch is supplied by the third one of the at least three control valves in the transmission.

18. The drivetrain of claim 17 wherein the first clutch is a multi-plate hydraulic clutch, engagable by increasing a hydraulic pressure to the first clutch and disengagable by reducing the hydraulic pressure to the first clutch; the second clutch is a multi-plate hydraulic clutch, engagable by increasing a hydraulic pressure to the second clutch and disengagable by reducing the hydraulic pressure to the second clutch; and the third clutch is a multi-plate hydraulic clutch, engagable by increasing a hydraulic pressure to the third clutch and disengagable by reducing the hydraulic pressure to the third clutch.

19. The drivetrain of claim 14 wherein the first clutch is a multi-plate hydraulic clutch, engagable by increasing a hydraulic pressure to the first clutch and disengagable by reducing the hydraulic pressure to the first clutch; the second clutch is a multi-plate hydraulic clutch, engagable by increasing a hydraulic pressure to the second clutch and disengagable by reducing the hydraulic pressure to the second clutch; and the third clutch is a multi-plate hydraulic clutch, engagable by increasing a hydraulic pressure to the third clutch and disengagable by reducing the hydraulic pressure to the third clutch.

20. The drivetrain of claim 14 wherein the transmission includes three planetary gear sets for selectively transmitting torque from the transmission input to the transmission output.
